(19) United States
(12) Patent Application Publication
(10) Pub. No.: US 2025/0353519 A1
(43) Pub. Date: Nov. 20, 2025

(54) INTELLIGENT VEHICLE NOTIFICATION SYSTEMS AND PROCESSES

(71) Applicant: Allstate Insurance Company, Northbrook, IL (US)

(72) Inventors: Tai-Yip Kwok, Northbrook, IL (US); Michael O'Connor, Northbrook, IL (US); Michael Steven Watson, Northbrook, IL (US)

(21) Appl. No.: 19/206,619

(22) Filed: May 13, 2025

Related U.S. Application Data
(60) Provisional application No. 63/647,261, filed on May 14, 2024.

(51) Int. Cl. B60W 50/14; G06N 3/08; G06Q 20/10; G06Q 20/36; G06Q 40/08

(52) U.S. Cl. CPC B60W 50/14; G06N 3/08; G06Q 20/102; G06Q 20/108; G06Q 20/36; G06Q 40/08; B60W 2050/143; B60W 2050/146; B60W 2556/50

(57) ABSTRACT

Systems and methods include generating a notification using audio, visual, tactile and/or other notification features via a vehicle notification system to a driver of a vehicle based on vehicle sensor data and/or external vehicle data regarding driver interest items such as road conditions, road hazards, nearby points of interest augmented image displays, pre-approved evacuation expenses, new driver quotes based on predicted new driver scores, insurance quotes based on bank account data, preapproved insurance related medical expenses, and the like.

### CROSS-REFERENCE TO RELATED APPLICATIONS

The present disclosure claims priority to U.S. Provisional Application No. 63/647,261, filed May 14, 2024, and entitled INTELLIGENT VEHICLE NOTIFICATION SYSTEMS AND PROCESSES, the entirety of which is incorporated by reference herein.

### BACKGROUND

Drivers may receive alerts from a vehicle when driving. For example, a light may flash as an alert on a side-view mirror when an object is in the vehicle's blind-spot. However, a need exists for more immersive and engaging vehicle alerts.

### SUMMARY

Aspects of the present disclosure relate to notification systems. In particular, aspects of the disclosure relate to notification systems integrated into a vehicle.

In an embodiment, a vehicle notification system comprises a notification feature communicatively coupled to a vehicle to notify a driver of the vehicle of a notification via the vehicle notification system, one or more vehicle sensors associated with the vehicle, one or more external data sources remote from the vehicle, at least one processor communicatively coupled to the notification feature, the one or more vehicle sensors, and the one or more external data sources, a memory communicatively coupled to the at least one processor, and one or more machine readable instructions stored in the memory that cause the vehicle notification system to perform at least the following when executed by the at least one processor: receive evacuation data and geographical evacuation zone data for a geographical evacuation zone from the one or more external data sources. The one or more machine readable instructions further cause the vehicle notification system to perform at least the following when executed by the at least one processor: determine as an eligibility determination that the vehicle is one of one or more eligible vehicles within the geographical evacuation zone based on the one or more vehicle sensors, and transmit the notification to the driver of the vehicle via the notification feature of available evacuation funds based on the eligibility determination.

In another embodiment, a method comprises receiving evacuation data and geographical evacuation zone data for a geographical evacuation zone from one or more external data sources remote from a vehicle, determining as an eligibility determination that the vehicle is one of one or more eligible vehicles within the geographical evacuation zone based on one or more vehicle sensors associated with the vehicle, and transmitting a notification to a driver of the vehicle via a notification feature communicatively coupled to the vehicle of available evacuation funds based on the eligibility determination.

In yet another embodiment, a vehicle notification system comprises a notification feature communicatively coupled to a vehicle to notify a driver of the vehicle of a notification via the vehicle notification system, one or more vehicle sensors associated with the vehicle, one or more external data sources remote from the vehicle, at least one processor communicatively coupled to the notification feature, the one or more vehicle sensors, and the one or more external data sources, a memory communicatively coupled to the at least one processor, and one or more machine readable instructions stored in the memory that cause the vehicle notification system to perform at least the following when executed by the at least one processor: request via the notification feature access to driver financial information associated with the driver of the vehicle. The one or more machine readable instructions further cause the vehicle notification system to perform at least the following when executed by the at least one processor: receive from the driver and via the notification feature permission to access the driver financial information for a set time period, access the driver financial information during the set time period, generate an insurance quote based on a plurality of metrics associated with the driver financial information during the set time period, and transmit the notification of the insurance quote to the driver of the vehicle via the notification feature.

In some instances, a driver may receive a notification from the vehicle that a potential road hazard exists. However, the driver may not be aware of the notification such as if the notification is on a vehicle side-view mirror and the driver is focused on the road. The systems and processes described herein notify the driver of potential road hazards through audio and visual notifications through, for example, vehicle speakers, vehicle lighting, and an augmented reality display.

### BRIEF DESCRIPTION OF THE DRAWINGS

The present disclosure is illustrated by way of example and not limited in the accompanying figures in which like reference numerals indicate similar elements and in which:

FIG. 1 depicts a vehicle with a plurality of vehicle sensors, according to one or more embodiments shown and described herein;

FIG. 2 schematically depicts a system diagram of a vehicle notification system associated with the vehicle of FIG. 1, according to one or more embodiments shown and described herein;

FIG. 3 schematically depicts a flowchart of a process for use with the vehicle and vehicle notification systems of FIGS. 1-2, the process directed to detecting a potential road hazard, according to one or more embodiments shown and described herein;

FIG. 4 schematically depicts a flowchart of another process for use with the vehicle and vehicle notification systems of FIGS. 1-2, the process directed to of display of images on an augmented reality display of the vehicle, according to one or more embodiments shown and described herein;

FIG. 5 schematically depicts a flowchart of yet another process for use with the vehicle and vehicle notification systems of FIGS. 1-2, the process directed to generation and distribution of evacuation funds to eligible drivers, according to one or more embodiments shown and described herein;

FIG. 6 schematically depicts a flowchart of another process for use with the vehicle and vehicle notification systems of FIGS. 1-2, the process directed to generating a new driver quote based on a predicted new driver score, according to one or more embodiments shown and described herein;

FIG. 7 schematically depicts a flowchart of yet another process for use with the vehicle and vehicle notification systems of FIGS. 1-2, the process directed to generating an insurance quote based on a driver bank account, according to one or more embodiments shown and described herein;

FIG. 8 schematically depicts a flowchart of another process for use with the vehicle and vehicle notification systems of FIGS. 1-2, the process directed to automatically approving claims for at least one preapproved medical expense, according to one or more embodiments shown and described herein; and

FIG. 9 schematically depicts a system for use with the vehicle and vehicle notification systems of FIGS. 1-2 and for implementing computer and software based processes as set forth in FIGS. 3-8, according to one or more embodiments shown and described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

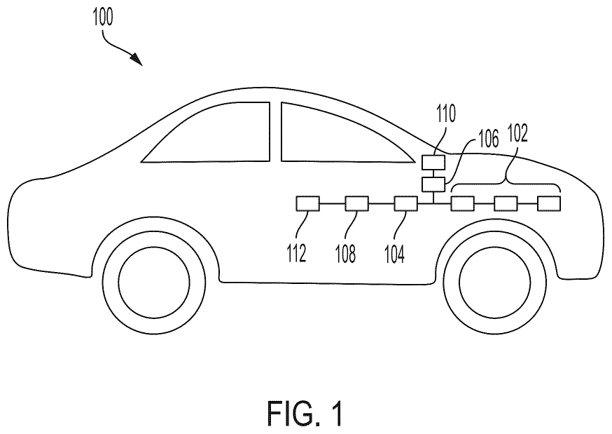

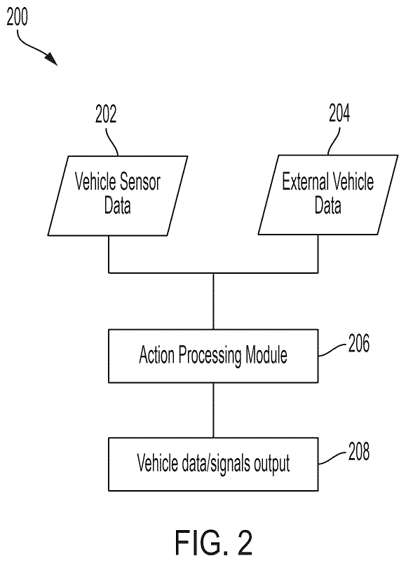

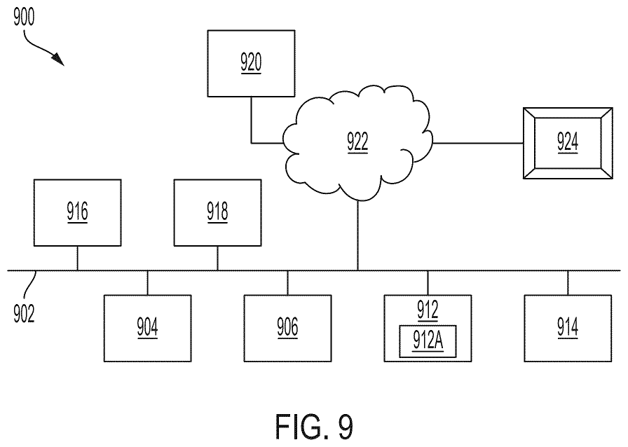

In embodiments described herein, a system 900 (FIG. 9) for use with a vehicle 100 (FIG. 1) and a vehicle notification system 200 (FIG. 2), each of which is described in greater detail further below, may be used to notify a driver of potential road hazards. The vehicle 100 may be an automotive vehicle such as a car, truck, recreational vehicle, or other similar automotive transport. The system 900 may utilize one or more artificial neural network (ANN) models as understood to those skilled in the art or as yet-to-be-developed to generate communications and alerts as described in embodiments herein. Such ANN models may include artificial intelligence components selected from the group that may include, but not be limited to, an artificial intelligence engine, Bayesian inference engine, and a decision-making engine, and may have an adaptive learning engine further comprising a deep neural network learning engine. The one or more ANN models may employ a combination of artificial intelligence techniques, such as, but not limited to, Deep Learning, Random Forest Classifiers, Feature extraction from audio, images, clustering algorithms, or combinations thereof. Such ANN models employing artificial intelligence (AI) may include masked language models, large language models, other generative AI transformer models such as encoder and/or decoder models, GPT style (auto-regressive training based), BERT style (auto-encoding training based), or BART/T5 style (sequence-to-sequence training based), conditional transformers, and the like developed or yet to be developed AI models and may employ agentic AI solutions such as to create independent action deployment and goal-oriented decision making systems utilizing AI agents.

As an example and not a limitation, a machine learning module of the ANN may include artificial intelligence components selected from the group consisting of an artificial intelligence engine, Bayesian inference engine, and a decision-making engine, and may have an adaptive learning engine further comprising a deep neural network learning engine. Data stored and manipulated in the vehicle notification system 200 as described herein is utilized by the machine learning module, which in embodiments able to leverage a cloud computing-based network configuration such as the cloud to apply machine learning and artificial intelligence or may be able to rely on an internal architecture to apply machine learning and artificial intelligence as described herein. This machine learning application may create models that can be applied by the intelligent machine learning to make it more efficient and intelligent in execution.

Referring to FIGS. 1, 2, and 9, a vehicle 100 may be communicatively coupled to the system 900 and include a plurality of vehicle sensors 102 to generate vehicle sensor data 202 for use as an input for the vehicle notification system 200. As depicted in the vehicle notification system 200 of the vehicle notification system associated with the vehicle 100 of FIG. 1, the vehicle sensor data 202 may then be used in combination with external vehicle data 204 as another input by an action processing module 206 to generate vehicle data and/or signals output 208. The vehicle data and/or signals output 208 may be executed by the action processing module 206 and may include vehicle notifications to the driver through vehicle components as shown in FIG. 1 of speakers 104, tactile alert module 106, vehicle lighting 108, and display 110 (that may be an augmented reality display 110). A driver may communicate with the system through a vehicle display (such as the augmented reality display 110 and/or other vehicle display types), user device such as a user mobile device, and/or through a microphone 112 within the vehicle 100.

Plurality of vehicle sensors: The plurality of vehicle sensors 102 may include a camera, an infrared sensor, and/or a proximity sensor. The camera may be a plurality of cameras may be included on the vehicle 100. The plurality of cameras may be configured to capture video inside or outside of the vehicle 100. The plurality of cameras may capture a front, rear, or side view of the vehicle 100. The infrared sensor may be configured to capture data as input to the system 900 for the system 900 (such as through the action processing module 206) to whether a road in a path of the vehicle 100 has ice on the road. For example, the infrared sensor may provide data as input such as a measurement of a temperature of the road the vehicle 100 is traveling on. The infrared sensor input may be used to determine when a portion of the road has a temperature below the freezing point of water (i.e., below 32° F.). When a portion of the road has a temperature below the freezing point of water, the action processing module 206 may notify the driver of a risk of icy roads through the speakers 104, tactile alert module 106 (such as to triggering a vibration as an alert), vehicle lighting 108, and/or the augmented reality display 110 (as explained further below). The plurality of cameras and/or the infrared sensor input may also be used by the action processing module 206 to sense a location and depth of a pothole in the road. The plurality of vehicle sensors 102 may also include a proximity sensor. The proximity sensor may be used to sense and identify a distance between the vehicle 100 and an object, such as a pedestrian or another vehicle 100.

The plurality of sensors 102 may be configured to provide input to the action processing module 206 to sense whether the object is a pedestrian, an animal, another vehicle 100, or any other object that may be in the path of the vehicle 100. Thus, the action processing module 206 may not only sense the distance between the vehicle 100 and the object, but what the object is. For example, the action processing module 206, based on information from the plurality of sensors 102, may determine that the object is 25 feet in front of the vehicle 100 and that the object is another vehicle. Alternatively, the action processing module 206 may determine that the object is 50 feet in front of the vehicle 100 and that the object is a pedestrian on a bicycle. In some embodiments, the plurality of sensors 102 may determine a velocity of the object, such that the plurality of sensors may sense whether the object is traveling toward the vehicle 100 and when the vehicle 100 will come into contact with the object.

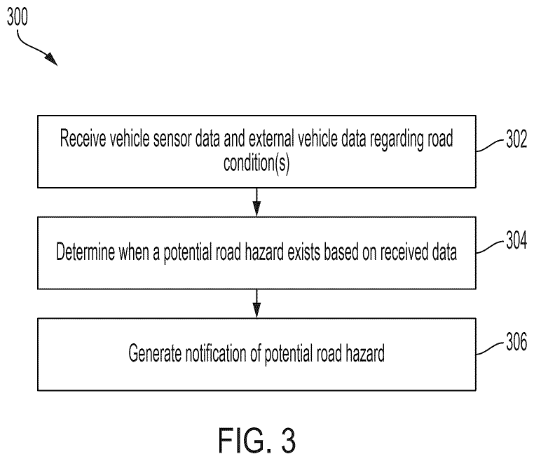

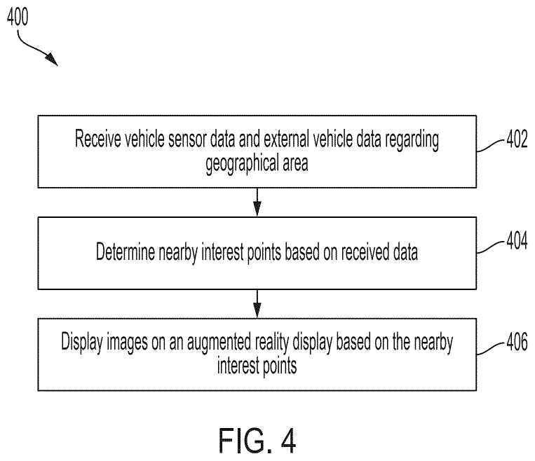

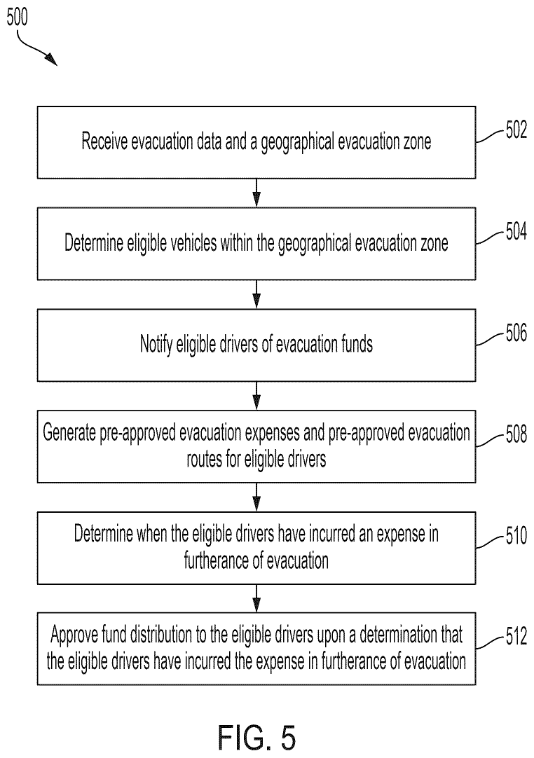

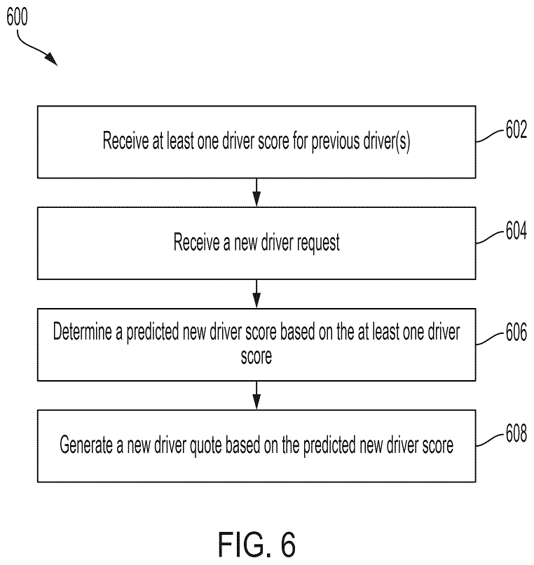

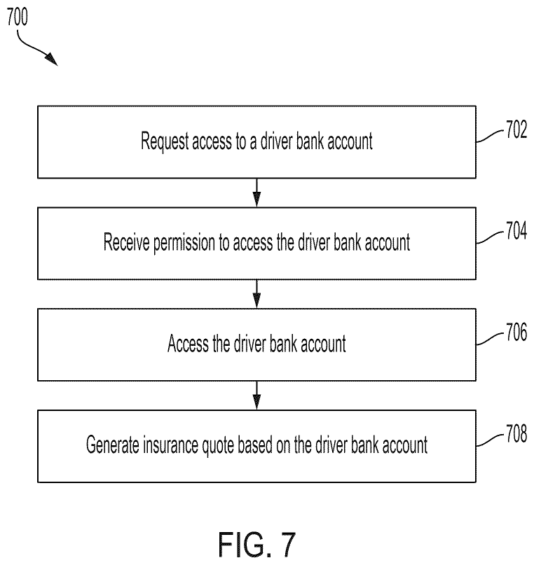

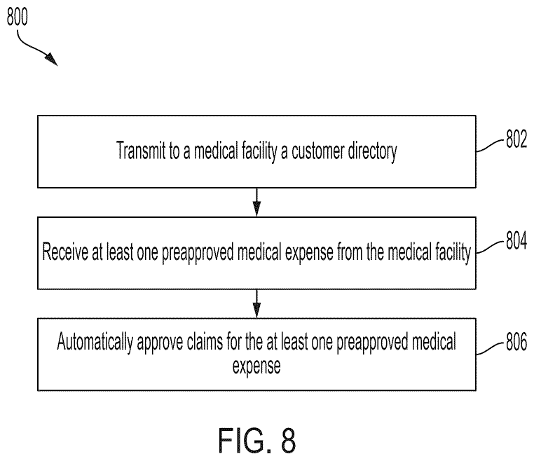

External Vehicle Data: Referring again to FIG. 2, the external vehicle data 204 may be an input into the action processing module 206. The external vehicle data 204 may include any data used by the action processing module 206 that does not come from the vehicle sensor data 202. As discussed further below, the external vehicle data 204 may include, and not be limited to, weather data, external vehicle data regarding road conditions (in block 302 of FIG. 3), geographical area data (in block 402 of FIG. 4), evacuation data and geographical evacuation zone data (in block 502 of FIG. 5), at least one driver score data (in block 602 of FIG. 6), a driver bank account data (in block 702 of FIG. 7), and a customer directory data (in block 802 of FIG. 8).

In embodiments, a vehicle notification system 200 as described herein (e.g., and as the system 900) may include a notification feature (e.g., via vehicle components as describe herein such as speakers 104, tactile alert module 106, vehicle lighting 108, and display 110 (that may be an augmented reality display 110) communicatively coupled to the vehicle 100 to notify a driver of the vehicle of a notification via the vehicle notification system 200, one or more vehicle sensors 102 associated with the vehicle 100 (e.g., to generate vehicle sensor data 202), one or more external data sources remote from the vehicle 100 (e.g., to generate external vehicle data 204, at least one processor communicatively coupled to the notification feature, the one or more vehicle sensors 102, and the one or more external data sources, a memory (e.g., memory component 906 of FIG. 9) communicatively coupled to the at least one processor 904 (FIG. 9), and one or more machine readable instructions stored in the memory (e.g., memory component 906) that cause the vehicle notification system 200 to perform at least one or more of the control schemes or processes as described herein, such as those of FIGS. 3-8 as set forth in greater detail below, when executed by the at least one processor 904.

Process for Generating Notification of Potential Road Hazard: Referring now to FIG. 3, a flowchart of a process 300 for use with the vehicle 100 of FIG. 1 and vehicle notification system 200 of FIG. 2 is depicted. In block 302, the vehicle sensor data 202 and the external vehicle data 204 regarding road conditions, as described hereinabove, are received by the action processing module 206. In block 304, it is determined whether a potential road hazard exists based on the received data (i.e., based on the vehicle sensor data 202 and the external vehicle data 204). Lastly, in block 306, the notification of a potential road hazard is generated. As discussed hereinabove, the notification of a potential road hazard may be expressed to the driver through the speakers 104, the vehicle lighting 108, and/or the augmented reality display 110.

Referring again to block 302, the external vehicle data 204 may include collective data from the vehicle sensor data 202 of a plurality of vehicles 100. For example, the plurality of vehicles 100 may be connected through a network. Each of the plurality of vehicles may produce vehicle sensor data 202 through the plurality of vehicle sensors 102. The vehicle sensor data 202 from each of the plurality of vehicles may be aggregated into the collective data, which may be included in the external vehicle data regarding road conditions in block 304.

Referring now to block 304, based on the collective data, various road conditions may be monitored. For example, it may be determined that a road has a pothole of a particular size at a particular geographic location on a road. Thus, the external vehicle data 204 may include data about whether a road has a pothole before the vehicle 100 travels down the road and senses the pothole through the plurality of vehicle sensors 102. The collective data may also monitor that traffic exists on a particular road if the vehicle sensor data 202 from the plurality of vehicles 100 indicates that the plurality of vehicles 100 are traveling in a speed slower than average for the particular road. The collective data may also include historical trends, such as historical weather data, historical traffic data, or historical road conditions.

In block 306, the action processing module 206 may generate the vehicle data and/or signals output 208. The vehicle data and/or signals output 208 may include a notification of potential road hazards to the driver through the speakers 104, vehicle lighting 108, and/or the augmented reality display 110. For example, if the action processing module 206 determines that a pothole exists on a road the vehicle 100 is traveling on based on data the vehicle sensor data 202 and/or the external vehicle data 204 regarding road conditions (i.e., the collective data), the vehicle data and/or signals output 208 may be expressed by the speakers 104 stating to the driver via speakers 104 an audio message that “pothole ahead on the right side of the road in 500 feet.” In block 306, the vehicle data and/or signals output 208 may also include a risk score of a particular road. The risk score may be associated with a risk of the vehicle 100 getting caught in traffic, a risk of the vehicle 100 hitting a pothole, or any other risk to the vehicle 100 or the driver. For example, if the vehicle 100 is on a highway at rush hour, the risk score that the vehicle 100 gets caught in traffic may be 90/100. The vehicle data and/or signals output 208 may be expressed by the speakers 104 to generate the notification of the potential road hazard by stating to the driver via speakers 104 an audio message that “traffic delays of up to an hour are extremely likely on this route.” The process 300 may also include suggesting via speakers 104 an audio message, and/or via display 110 a visual message, regarding alternative routes to the driver where traffic is less likely. In other embodiments, the vehicle lighting 108 may also be used to issue alerts to the driver via lighting displays (such as red for caution), that may be used in addition or alternatively to the display 110.

In some embodiments, the vehicle lighting 108 may blink different colors based on the alert given to the driver. For example, the vehicle lighting may blink orange when alerting the driver of a pothole. Alternatively, the vehicle lighting 108 may blink blue when alerting the driver of expected traffic delays ahead. The vehicle data and/or signals output 208 may also be presented to the driver through the augmented reality display 110.

In other embodiments, the augmented reality display 110 may highlight road hazards, signs, or other features of the environment of the vehicle 100. For example, if a pedestrian is in front of the vehicle 100, a heads up display (HUD) (e.g., display 110) may outline the pedestrian in a red outline to alert the driver of the pedestrian. In other embodiments, a pothole that would have otherwise been imperceptible by the driver may be outlined in orange by the HUD to alert the driver of the pothole.

Process for Display of Images on an Augmented Reality Display: FIG. 4 depicts a flowchart of another process for use with the vehicle 100 and vehicle notification system 200 directed to the display of images on the augmented reality display 110. The augmented reality display 110 may be presented on a vehicle windshield through the HUD. Thus, the HUD allows the driver to view information presented by the augmented reality display 110 without taking their eyes off of the road.

In block 402, the vehicle sensor data 202 and the external vehicle data 204 regarding geographical area are received. The external vehicle data 204 regarding geographical area may include a geographical area where the vehicle 100 is located or a geographical area the vehicle 100 is expected to travel. In block 404, nearby interest points based on the received data (i.e., the vehicle sensor data 202 and the external vehicle data 204 regarding geographical area) are determined. The nearby interest points may be restaurants, supermarkets, music venues, sports stadiums, or any other location that may be of interest to the driver. The data may be received via a location and/or navigation module mapping system as well, such as via using a global positioning system (GPS).

In block 406, images are displayed on the augmented reality display 110 based on the nearby interest points. The images may be advertisements on the HUD. The advertisements may include images or videos displayed on a business in view of the driver through the windshield of sensed nearby interests points within a predetermined distance of the location of the vehicle 100. For example, if the vehicle 100 is driving through a shopping district, the augmented reality display 110 may project advertisements for nearby stores. The advertisements may include discounted prices, images of discounted goods, or a company logo.

In some embodiments, the augmented reality display 110 may include images of upcoming events at a sports stadium that the vehicle 100 is driving by. For example, if the vehicle 100 is driving by a football stadium that is to host a home football game that week, the HUD may display an image of the football team's logo and a date of the home football game. The speakers 104 and the vehicle lighting 108 may also communicate information to the driver based on the nearby interest points. Based on the foregoing example, the speakers 104 may announce the time and date of the home football game, and the vehicle lighting 108 may turn to the home football team's colors. The driver may communicate with the system 900 through the microphone 112 that the driver would like to purchase tickets. Alternatively, the driver may communicate through the microphone 112 that the driver is not interested in football and would not like to receive any further notifications regarding football games or may only wish to receive information for certain teams. Thus, the information displayed or otherwise presented to the driver via notifications may be based on driver preferences.

Process for Generation and Distribution of Evacuation Funds: Referring now to FIG. 5, a flowchart of another process 500 for use with the vehicle 100 and vehicle notification system 200 directed to generation and distribution of evacuation funds to eligible drivers is depicted. The process 500 advances funds to evacuees prior to the time of evacuation, or in real-time, to gives the evacuees the necessary funds required to execute a successful evacuation.

In embodiments, the one or more machine readable instructions stored in the memory (e.g., memory component 906) cause the vehicle notification system 200 to perform at least the following blocks of blocks 502-512 as described in greater detail below when executed by the at least one processor 904.

In block 502, the evacuation data and geographical evacuation zone data of the external vehicle data 204 is received. The evacuation data and geographical evacuation zone data for a geographical evacuation zone may be received from the one or more external data sources. The evacuation data and geographical evacuation zone data for the geographical zone may include data indicative of a mandatory evacuation associated with the geographical evacuation zone. The evacuation data and geographical evacuation zone may include whether a mandatory evacuation has been issued for a particular geographic area. For example, a governor of a state may issue a mandatory evacuation for all citizens located within a 100 mile radius of a potential hurricane path. The evacuation data and the geographical evacuation zone includes both whether the mandatory evacuation has been issued, and also the location for which the mandatory evacuation has been issued.

In an aspect, an artificial intelligence neural network trained model of the artificial intelligence component 912 may be used to identify the geographical evacuation zone, one or more risk levels (e.g., high, medium, or low based on one or more zone risk scores to risk level threshold comparisons) associated with the geographical evacuation zone (or sub-zones), a recommended time (e.g., for the vehicle 100 post evacuation) after which to return to the geographical evacuation zone, or combinations thereof.

In block 504, eligible vehicles 100 within the geographical evacuation zone are determined. Eligible vehicles 100 may be those who are covered by an insurance policy of an insurer and located within the geographical evacuation zone. Vehicles 100 covered by the insurer may be determined by a customer database, which may include all vehicles and/or drivers covered by the insurer. The location of the vehicles may be determined by using location services such as the respective GPS of the eligible vehicle 100 (which may be included in the plurality of sensors 102 of the vehicle 100) and/or a customer location listed in the customer database associated with the vehicles and/or drivers covered by the insurer.

In an embodiment, as an eligibility determination, the vehicle 100 of a driver is determined as one of one or more eligible vehicles 100 within the geographical evacuation zone based on the one or more vehicle sensors 102. The vehicle 100 may be determined to be one of the one or more eligible vehicles 100 within the geographical evacuation zone based on (i) location information from the one or more vehicle sensors 102, (ii) the one or more external data sources comprising insurance coverage information for the vehicle 100, or (iii) combinations thereof.

A location of the vehicle may be determined for the eligibility determination through one or more sensors indicative of at least one of location information, evacuation data, or geographical zone data. The one or more sensors may include the one or more vehicle sensors 102, the one or more external data sources, or combinations thereof. The one or more sensors to determine the location of the vehicle may further include at least one of: a global positioning system (GPS) of the vehicle 100, a GPS of a user device communicatively coupled to the vehicle 100, one or more wireless communication sensors of the vehicle 100, one or more wireless communication sensors of the user device, one or more networked sensors, or combinations thereof. The one or more networked sensors may include at least one or more home-based sensors, one or more application sensors, and/or one or more wearable sensors.

In block 506, the eligible drivers may be notified of evacuation funds. In an aspect, the notification may be transmitted to the driver of the vehicle via the notification feature of available evacuation funds based on the eligibility determination. The eligible drivers in respective vehicles 100 may be notified of evacuation funds through the speakers 104, the vehicle lighting 108, and/or the augmented reality display 110 of their vehicle 100. In some embodiments, the eligible driver may accept the funds through stating “I accept” through the microphone 112 of the vehicle 100. In other embodiments, the eligible drivers may be notified of the evacuation funds through other means, such as through a text message, a phone call, an email, a push notification, or any other suitable means of notifying the eligible drivers, such as through their mobile client devices.

In an aspect, the notification to the driver may be transmitted via a first type of the notification feature. The notification feature may include one or more of a speaker feature (e.g., speaker 104), a microphone feature (e.g., microphone 112), a lighting feature (e.g., vehicle lighting 108), an augmented reality display of the vehicle (e.g., display 110), a graphical user interface such as of a user mobile device or the vehicle 100 and associated display (e.g., display 110), or combinations thereof. An acceptance of the available evacuation funds offered may be received via the notification transmitted to the driver through a second type of the notification feature, which may be one of the same or different (e.g., the same or other vehicle components or means as set forth above) from the first type of the notification feature.

In block 508, pre-approved evacuation expenses and pre-approved evacuation routes for the eligible drivers are generated. In an aspect, one or more pre-approved evacuation expenses may be generated as part of the available evacuation funds. The one or more pre-approved evacuation expenses may include expenses associated with gasoline for the vehicle, lodging for the driver, groceries, meals, or combinations thereof. Pre-approved evacuation expenses may include expenses in the course of evacuation. For example, pre-approved evacuation expenses may include gasoline, a hotel room, groceries, restaurant meals, and/or any other expense that may be in the course of evacuation. Moreover, the preapproved evacuation expenses may only be available on the pre-approved evacuation routes. The one or more pre-approved evacuation routes may be generated for the driver of the vehicle 100, wherein the one or more pre-approved evacuation expenses are available on the one or more pre-approved evacuation routes, and the one or more pre-approved evacuation expenses and the one or more pre-approved evacuation routes may be transmitted along with an evacuation plan to the driver prior to an evacuation. The pre-approved evacuation routes may be the most efficient route to evacuate the geographical evacuation zone. The eligible drivers may be notified of the pre-approved evacuation expenses and the pre-approved evacuation routes prior to evacuation, such that the eligible drivers may receive an evacuation plan with locations of pre-approved gas stations, hotels, and restaurants.

Referring now to block 510, it may be determined when the eligible drivers have incurred an expense in furtherance of evacuation. The vehicle notification system 200 may determine as an evacuation expense determination when the driver of the vehicle 100 has incurred an expense as one of the one or more pre-approved expenses in furtherance of evacuation, and fund distribution to the driver of the vehicle 100 may be approved upon the evacuation expense determination. In some embodiments, an expense in furtherance of evacuation is simply an expense that is a pre-approved evacuation expense and along or near the pre-approved evacuation route. For example, if hotels are a pre-approved evacuation expense and the pre-approved evacuation route is along Interstate 75, hotels within 5 miles off of Interstate 75 may be considered an expense in furtherance of evacuation. Alternatively, if a new laptop computer is bought by the eligible driver within 5 miles off of Interstate 75, this expense may not be determined to be in furtherance of evacuation.

In block 512, fund distribution to the eligible drivers may be approved upon a determination that the eligible drivers have incurred the expense in furtherance of evacuation. If it is determined that the eligible drivers have incurred the expense in furtherance of evacuation, funds may be distributed to the eligible drivers in real-time. The funds (in portion or in total) may be electronically distributed upon approval to the driver of the vehicle 100 in real-time or upon a determination based on the one or more vehicle sensors 102 that the vehicle 100 is outside the geographical evacuation zone to an associated bank account or digital wallet of the driver. The funds may be distributed to the eligible drivers through a bank account of the eligible driver, a digital wallet of the eligible driver, or any other suitable means to distribute the funds to the eligible drivers instantly. In some embodiments, the fund distribution to the eligible drivers may be dependent upon the eligible drivers having drove the vehicle 100 outside of the geographical evacuation zone.

Process for Generating New Driver Quote Based on a Predicted Driver Score: Referring now to FIG. 6, a flowchart for another process 600 for use with the vehicle 100 and vehicle notification system 200 directed to generating a new driver quote based on a predicted new driver score is depicted. The process 600 is used to generate a new driver quote. The new driver quote may be based on a predicted driver score, which may be predicted based on at least one driver score. The at least one driver score may be generated by monitoring a plurality of vehicle metrics, including the vehicle 100 acceleration, braking, turning, and location. The plurality of vehicle metrics may also include vehicle usage, safeness of parking locations, or security systems installed in the vehicle 100 The plurality of vehicle metrics may be recorded through the plurality of vehicle sensors 102, which may include an accelerometer, GPS, and gyroscopic sensors of the vehicle 100.

In block 602, at least one driver score for a previous driver, or drivers, is received. The at least one driver score may be obtained from a driver score database. The at least one driver score represents the driver's level of safe driving based on the plurality of vehicle metrics over time. The at least one driver score may represent a likelihood that the at least on driver will be involved in an automobile accident. A high driver score may represent a high level of safe driving, while a low driving score may represent a low level of safe driving.

In block 604, new driver request is received. The new driver request could be for a new driver. A driver may be considered a new driver because the driver just obtained a license to drive, the driver was not previously insured with the at least one driver, or there was simply no previous driver score for the driver.

In block 606, a predicted new driver score is determined based on the at least one driver score. The predicted new driver score may be high, low, or average when based on the at least one driver score; the predicted new driver score represents a predicted level of safety the new driver will drive with. For example, a first driver of a family may have a driver score of 90/100; a second driver of a family may have a driver score of 80/100. The predicted new driver score for a child of the family who has just obtained a license may be 85/100. In other embodiments, the predicted new driver score may be based on factors other than the at least one driver score. For example, the predicted new driver score may also be based on age, gender, or any other metric that may affect the new driver's predicted level of safe driving. For instance, in the example above, the predicted new driver score may nevertheless be 65/100 if the child who had just obtained a license is 16 years old and a male.

In block 608, a new driver quote based on the predicted new driver score is generated. The new driver quote may be a monthly premium for the new driver to be insured. The new driver quote may be inversely correlated to the predicted new driver score, such that a higher predicted new driver score results in a lower new driver quote, and a lower predicted new driver score results in a higher new driver quote. For example, a predicted new driver score of 60/100 may result in the generation of a new driver quote of $140 per month, while a predicted new driver score of 90/100 may result in the generation of a new driver quote of $120 per month.

The process 600 may also include informing the driver of ways to improve the driver score. For example, the driver may receive a list of which plurality of driving metrics are decreasing the driver score (hard braking or sharp turns) and which plurality of driving metrics are increasing the driver score (mild acceleration and low vehicle usage). Based on the list of the plurality of driving metrics decreasing or increasing the driver score, the driver may improve safc driving, improve the driver score, resulting in an increase of the drive scope, and thus, receive a lower quote. The driver score may change in real-time, weekly, monthly, or yearly based on the plurality of driving metrics.

While embodiments of the process 600 described hereinabove are directed to generating the new driver quote based on the predicted driver score, it should be understood that the process 600 may also be applied to generating a homeowner quote based on a predicted homeowner score. For example, the predicted homeowner score could be based on a plurality of home factors, such as whether a home has a security system, whether the home has a sump pump monitor, or whether the home has a smart thermostat. Based on the plurality of home factors, a predicted homeowner score could be calculated and, thus, the homeowner quote could be generated. Similar to the predicted new driver score, the higher the homeowner score the lower the homeowner quote would be. In some embodiments, the driver score and the homeowner score may be combined or bundled, from which a bundled vehicle and homeowner quote is generated based on both the driver score and the homeowner score.

Process for Generating an Insurance Quote Based on a Driver Bank Account: Referring now to FIG. 7, a flowchart of another process 700 for use with the vehicle 100 and vehicle notification system 200 directed to generating an insurance quote based on a driver bank account is depicted. The process 700 is used to generate an insurance quote that is based on a driver's bank account, rather than a driver credit score. This may be preferable for the driver because a credit check may negatively affect the driver credit score. Moreover, the driver may prefer the driver credit score not be accessed because the driver credit score is low.

In embodiments, the one or more machine readable instructions stored in the memory (e.g., memory component 906) cause the vehicle notification system 200 to perform at least the following blocks of blocks 702-708 as described in greater detail below when executed by the at least one processor 904.

Access to driver financial information associated with the driver of the vehicle 100 can be requested via the notification feature as described herein. In an embodiment, the driver financial information may include a driver bank account associated with the driver of the vehicle 100. The driver financial information may include a plurality of metrics indicative of an ability of the driver to pay an insurance quote as described in greater detail further below.

In an embodiment, in block 702, access to a driver bank account is requested. Access to the driver bank account can be requested through the driver. Access can be requested through phone call, push notification, waiver request, or any other suitable means for requesting access. In some embodiments, access can be requested directly through the driver, while in other embodiments access can be requested through the driver bank when the driver has authorized the bank to accept such a request. From the driver and via the notification feature, permission to access the driver financial information for a set time period may be received, and the driver financial information may be accessed during the set time period.

In embodiments, after the driver receives the request to access the driver bank account, permission to access the driver bank account is received in block 704. The driver may give permission to access the driver bank account through verbal, written, or electronic verification. The permission to access the driver bank account may be for a set time period or the permission to access the driver bank account may be indefinite, terminating only upon the driver revoking the permission. In embodiments, a record of the permission to access the driver bank account may be stored on a driver bank account database.

The driver bank account is accessed in block 706. The driver bank account may include a plurality of account metrics as the plurality of metrics, including an account number, checking account balance, savings account balance, transaction history, account fees, credit card accounts, and/or account status. A driver income may also be included in the plurality of account metrics, which may be based on checks cashed in the driver bank account.

Based on the driver bank account, an insurance quote may be generated in block 708. The insurance quote may be based on the plurality of account metrics. The plurality of metrics may reflect a driver's ability to pay the insurance quote. Thus, an insurer generating the insurance quote would not be required to check the driver credit score. The insurance quote may be generated as described herein based on the plurality of metrics associated with the driver financial information during the set time period, and the notification of the insurance quote may be transmitted to the driver of the vehicle 100 via the notification feature.

In embodiments, and for any the processes 300-800 of FIGS. 3-8 as described herein, the notification to the driver may be transmitted via a first type of the notification feature, the notification feature comprising one or more of a speaker feature (e.g., speaker 104), a microphone feature (e.g., microphone 112), a lighting feature (e.g., vehicle lighting 108), an augmented reality display of the vehicle (e.g., display 110), a graphical user interface such as of a user mobile device or the vehicle 100 and associated display (e.g., display 110), or combinations thereof. An acceptance (e.g., of the insurance quote offered via the notification transmitted to the driver) may be received through a second type of the notification feature. The second type of the notification feature is one of the same or different from the first type of the notification feature.

Process for Automatically Approving Claims for at Least One Preapproved Medical Expense: Referring now to FIG. 8, a flowchart of a process 800 for use with the vehicle 100 and the vehicle notification system 200 directed to automatically approving claims for at least one preapproved medical expense is depicted. The process 800 for automatically preapproving medical expenses permits medical facilities to quickly or automatically receive guaranteed payment from the insurer for preapproved medical expenses. This generates a streamlined claims process, resulting in cheaper and quicker claims processing.

In block 802, a customer directory is transmitted to a medical facility. The customer directory may be the customer directory of the insurer. The customer directory may include all customers that have purchased insurance from the insurer. In other embodiments, the customer directory transmitted to the medical facility may only include customers that have purchased a certain type of insurance from the insurer. The medical facility may include an urgent care, hospital, emergency care facility, or primary care physician.

At least one preapproved medical expense is received from the medical facility in block 804. The at least one preapproved medical expense may include treatment for certain medical conditions or certain medical procedures; in some embodiments, the at least one preapproved medical expense includes only injuries related to an auto accident for which the insurer would be liable to pay a claim. For example, treatment or surgery for a fractured wrist may be included in the at least one preapproved medical expense, while treatment for diabetes may not be included in the at least one preapproved medical expense. The medical facility sends the at least one preapproved medical expense to the insurer in block 804.

Claims may be automatically approved for the at least one preapproved medical expense in block 806. Upon receiving a claim from the medical facility for the at least one preapproved medical expense, the insurer may automatically approve the claim if the at least one preapproved medical expense was performed on an insured customer in the customer directory that was transmitted to the medical facility. As discussed hereinabove, the medical facility may receive the claim much faster under the process 800 to automate approval when compared to traditional processes of submitting a claim to an insurer for a medical expense that has not been preapproved. Moreover, the process 800 may save the insurer time and money, streamlining the insurer's processing of the claims.

System for Implementing Computer Software Based Processes 300-800 as Set Forth Above: Referring to FIG. 9, the system 900 for implementing a computer and software-based method, such as via those of FIGS. 3-8, to generate vehicle data/signals output 208 based on the vehicle sensor data 202 and the external vehicle data 204 is depicted. The system 900 may be implemented along with using a graphical user interface (GUI) that is accessible at a user workstation (e.g., a mobile device associated with the lead/potential lead, such as a computer 924), for example. The user workstation may be a smart mobile device of a user (i.e. user mobile device), which may be a smartphone, a tablet, or a like portable handheld smart device. As a non-limiting example, the smart mobile device may be a smartphone or a tablet. The smart mobile device includes a camera, a processor, a memory communicatively coupled to the processor, and machine readable instructions stored in the memory. The machine readable instructions may cause the system 900 to, when executed by the processor, launch and operate a software application tool on the smart mobile device. The machine readable instructions may cause the system 900 to, when executed by the processor, use the functionality provided by the software application tool to follow one or more control schemes as set forth in the one or more processes described herein.

The system 900 includes machine readable instructions stored in non-transitory memory that cause the system 900 to perform one or more of instructions when executed by the one or more processors, as described in greater detail below. The system 900 includes a communication path 902, one or more processors 904, a memory component 906, an artificial intelligence component 912 (including machine learning component 912A), a storage or database 914, an action processing component 916 (communicatively coupled to action processing module 206), a network interface hardware 918, a server 920, a network 922, and at least one computer 924 (as a user workstation that may be, for example, a mobile device). The various components of the system 900 and the interaction thereof will be described in detail below.

In some embodiments, the system 900 is implemented using a wide area network (WAN) or network 922, such as an intranet or the Internet, or other wired or wireless communication network that may include a cloud computing-based network configuration. The computer 924 may include digital systems and other devices permitting connection to and navigation of the network, such as the smart mobile device. Other system 900 variations allowing for communication between various geographically diverse components are possible. The lines depicted in FIG. 9 indicate communication rather than physical connections between the various components.

As noted above, the system 900 includes the communication path 902. The communication path 902 may be formed from any medium that is capable of transmitting a signal such as, for example, conductive wires, conductive traces, optical waveguides, or the like, or from a combination of mediums capable of transmitting signals. The communication path 902 communicatively couples the various components of the system 900. As used herein, the term “communicatively coupled” means that coupled components are capable of exchanging data signals with one another such as, for example, electrical signals via conductive medium, electromagnetic signals via air, optical signals via optical waveguides, and the like.

As noted above, the system 900 includes the processor 904. The processor 904 can be any device capable of executing machine readable instructions. Accordingly, the processor 904 may be a controller, an integrated circuit, a microchip, a computer, or any other computing device. The processor 904 is communicatively coupled to the other components of the system 900 by the communication path 902. Accordingly, the communication path 902 may communicatively couple any number of processors with one another, and allow the modules coupled to the communication path 902 to operate in a distributed computing environment. Specifically, each of the modules can operate as a node that may send and/or receive data. The processor 904 may process the input signals received from the system modules and/or extract information from such signals.

As noted above, the system 900 includes the memory component 906 which is coupled to the communication path 902 and communicatively coupled to the processor 904. The memory component 906 may be a non-transitory computer readable medium or non-transitory computer readable memory and may be configured as a nonvolatile computer readable medium. The memory component 906 may comprise RAM, ROM, flash memories, hard drives, or any device capable of storing machine readable instructions such that the machine readable instructions can be accessed and executed by the processor 904. The machine readable instructions may comprise logic or algorithm(s) written in any programming language such as, for example, machine language that may be directly executed by the processor 904, or assembly language, object-oriented programming (OOP), scripting languages, microcode, etc., that may be compiled or assembled into machine readable instructions and stored on the memory component 906. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In embodiments, the system 900 may include the processor 904 communicatively coupled to the memory component 906 that stores instructions that, when executed by the processor 904, cause the processor 904 to perform one or more functions as described herein.

Still referring to FIG. 9, as noted above, the system 900 comprises the display such as a GUI on a screen of the computer 924 for providing visual output such as, for example, information, graphical reports, messages, or a combination thereof. The computer 924 may include one or more computing devices across platforms, or may be communicatively coupled to devices across platforms, such as smart mobile devices including smartphones, tablets, laptops, and/or the like. The display on the screen of the computer 924 is coupled to the communication path 902 and communicatively coupled to the processor 904. Accordingly, the communication path 902 communicatively couples the display to other modules of the system 900. The display can include any medium capable of transmitting an optical output such as, for example, a cathode ray tube, light emitting diodes, a liquid crystal display, a plasma display, or the like. Additionally, it is noted that the display or the computer 924 can include at least one of the processor 904 and the memory component 906. While the system 900 is illustrated as a single, integrated system in FIG. 9, in other embodiments, the systems can be independent systems.

The system 900 comprises the action processing component 916 to automate vehicle data/signals output 208 based on receiving input data as described herein from vehicle sensor data 202 and vehicle data and/or signals output 204 and the artificial intelligence component 912 to train and provide machine learning capabilities via machine learning component 912A to a neural network to aid with vehicle data and/or signals output 204 as described herein. The action processing component 916 and the artificial intelligence component 912 are coupled to the communication path 902 and communicatively coupled to the processor 904. The processor 904 may process the input signals received from the system modules and/or extract information from such signals.

Data stored and manipulated in the system 900 as described herein is utilized by the artificial intelligence component 912, which is able to leverage a cloud computing-based network configuration such as the cloud to apply Machine Learning and Artificial Intelligence. This machine learning application may create models that can be applied by the system 900, to make it more efficient and intelligent in execution. As an example and not a limitation, the artificial intelligence component 912 may include components selected from the group consisting of an artificial intelligence engine, Bayesian inference engine, and a decision-making engine, and may have an adaptive learning engine further comprising a deep neural network learning engine.

The system 900 includes the network interface hardware 918 for communicatively coupling the system 900 with a computer network such as network 922. The network interface hardware 918 is coupled to the communication path 902 such that the communication path 902 communicatively couples the network interface hardware 918 to other modules of the system 900. The network interface hardware 918 can be any device capable of transmitting and/or receiving data via a wireless network. Accordingly, the network interface hardware 918 can include a communication transceiver for sending and/or receiving data according to any wireless communication standard. For example, the network interface hardware 918 can include a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 9, data from various applications running on computer 924 can be provided from the computer 924 to the system 900 via the network interface hardware 918. The computer 924 can be any device having hardware (e.g., chipsets, processors, memory, etc.) for communicatively coupling with the network interface hardware 918 and a network 922.

Specifically, the computer 924 can include an input device having an antenna for communicating over one or more of the wireless computer networks described above.

The network 922 can include any wired and/or wireless network such as, for example, wide area networks, metropolitan area networks, the Internet, an Intranet, the cloud, satellite networks, or the like. Accordingly, the network 922 can be utilized as a wireless access point by the computer 924 to access one or more servers (e.g., a server 920). The server 920 and any additional servers such as a cloud server generally include processors, memory, and chipset for delivering resources via the network 922. Resources can include providing, for example, processing, storage, software, and information from the server 920 to the system 900 via the network 922. Additionally, it is noted that the server 920 and any additional servers can share resources with one another over the network 922 such as, for example, via the wired portion of the network, the wireless portion of the network, or combinations thereof.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A vehicle notification system, the vehicle notification system comprising:
a notification feature communicatively coupled to a vehicle to notify a driver of the vehicle of a notification via the vehicle notification system;
one or more vehicle sensors associated with the vehicle;
one or more external data sources remote from the vehicle;
at least one processor communicatively coupled to the notification feature, the one or more vehicle sensors, and the one or more external data sources;
a memory communicatively coupled to the at least one processor; and
one or more machine readable instructions stored in the memory that cause the vehicle notification system to perform at least the following when executed by the at least one processor:
receive evacuation data and geographical evacuation zone data for a geographical evacuation zone from the one or more external data sources;
determine as an eligibility determination that the vehicle is one of one or more eligible vehicles within the geographical evacuation zone based on the one or more vehicle sensors; and
transmit the notification to the driver of the vehicle via the notification feature of available evacuation funds based on the eligibility determination.

2. The vehicle notification system of claim 1, wherein a location of the vehicle is determined for the eligibility determination through one or more sensors indicative of at least one of location information, evacuation data, or geographical zone data, the one or more sensors comprising the one or more vehicle sensors, the one or more external data sources, or combinations thereof, the one or more sensors to determine the location of the vehicle further comprising at least one of:
a global positioning system of the vehicle;
a global positioning system of a user device communicatively coupled to the vehicle;
one or more wireless communication sensors of the vehicle;
one or more wireless communication sensors of the user device;
one or more networked sensors further comprising at least one or more home-based sensors, application sensors, or wearable sensors; or
combinations thereof.

3. The vehicle notification system of claim 1, wherein the one or more machine readable instructions cause the vehicle notification system to further perform at least the following when executed by the at least one processor:
identifying, using an artificial intelligence neural network trained model, the geographical evacuation zone, one or more risk levels associated with the geographical evacuation zone, a recommended time after which to return to the geographical evacuation zone, or combinations thereof.

4. The vehicle notification system of claim 1, wherein the evacuation data and geographical evacuation zone data for the geographical evacuation zone comprises data indicative of a mandatory evacuation associated with the geographical evacuation zone.

5. The vehicle notification system of claim 1, wherein the one or more machine readable instructions cause the vehicle notification system to further perform at least the following when executed by the at least one processor:
determine the vehicle is one of the one or more eligible vehicles within the geographical evacuation zone based on (i) location information from the one or more vehicle sensors, (ii) the one or more external data sources comprising insurance coverage information for the vehicle, or (iii) combinations thereof.

6. The vehicle notification system of claim 1, wherein the one or more machine readable instructions cause the vehicle notification system to further perform at least the following when executed by the at least one processor:
transmit the notification to the driver via a first type of the notification feature, the notification feature comprising one or more of a speaker feature, a lighting feature, an augmented reality display of the vehicle, a graphical user interface, or combinations thereof; and
receive an acceptance of the available evacuation funds offered via the notification transmitted to the driver through a second type of the notification feature.

7. The vehicle notification system of claim 1, wherein the one or more machine readable instructions cause the vehicle notification system to further perform at least the following when executed by the at least one processor:
generate one or more pre-approved evacuation expenses as part of the available evacuation funds.

8. The vehicle notification system of claim 7, wherein the one or more pre-approved evacuation expenses comprise expenses associated with gasoline for the vehicle, lodging for the driver, groceries, meals, or combinations thereof.

9. The vehicle notification system of claim 7, wherein the one or more machine readable instructions cause the vehicle notification system to further perform at least the following when executed by the at least one processor:
generate one or more pre-approved evacuation routes for the driver of the vehicle, wherein the one or more pre-approved evacuation expenses are available on the one or more pre-approved evacuation routes; and
transmit the one or more pre-approved evacuation expenses and the one or more pre-approved evacuation routes along with an evacuation plan to the driver prior to an evacuation.

10. The vehicle notification system of claim 7, wherein the one or more machine readable instructions cause the vehicle notification system to further perform at least the following when executed by the at least one processor:
determine as an evacuation expense determination when the driver of the vehicle has incurred an expense as one of the one or more pre-approved evacuation expenses in furtherance of evacuation; and
approve fund distribution to the driver of the vehicle upon the evacuation expense determination.

11. The vehicle notification system of claim 1, wherein the one or more machine readable instructions cause the vehicle notification system to further perform at least the following when executed by the at least one processor:
determine as an evacuation expense determination when the driver of the vehicle has incurred an expense in furtherance of evacuation; and
approve fund distribution to the driver of the vehicle upon the evacuation expense determination.

12. The vehicle notification system of claim 11, wherein the one or more machine readable instructions cause the vehicle notification system to further perform at least the following when executed by the at least one processor:
electronically distribute funds upon approval to the driver of the vehicle in real-time to an associated bank account or digital wallet of the driver.

13. The vehicle notification system of claim 11, wherein the one or more machine readable instructions cause the vehicle notification system to further perform at least the following when executed by the at least one processor:
electronically distribute funds upon approval to the driver of the vehicle to an associated bank account or digital wallet of the driver upon a determination based on the one or more vehicle sensors that the vehicle is outside the geographical evacuation zone.

14. A method comprising:
receiving evacuation data and geographical evacuation zone data for a geographical evacuation zone from one or more external data sources remote from a vehicle;
determining as an eligibility determination that the vehicle is one of one or more eligible vehicles within the geographical evacuation zone based on one or more vehicle sensors associated with the vehicle; and
transmitting a notification to a driver of the vehicle via a notification feature communicatively coupled to the vehicle of available evacuation funds based on the eligibility determination.

15. The method of claim 14, further comprising:
determining the vehicle is one of the one or more eligible vehicles within the geographical evacuation zone based on (i) location information from the one or more vehicle sensors, (ii) the one or more external data sources comprising insurance coverage information for the vehicle, or (iii) combinations thereof.
transmitting the notification to the driver via a first type of the notification feature, the notification feature comprising one or more of a speaker feature, a lighting feature, an augmented reality display of the vehicle, a graphical user interface, or combinations thereof; and
receiving an acceptance of the available evacuation funds offered via the notification transmitted to the driver through a second type of the notification feature.

16. The method of claim 14, further comprising:
determining as an evacuation expense determination when the driver of the vehicle has incurred an expense in furtherance of evacuation; and
approving fund distribution to the driver of the vehicle upon the evacuation expense determination.

17. The method of claim 16, further comprising:
electronically distributing funds upon approval to the driver of the vehicle in real-time to an associated bank account or digital wallet of the driver.

18. A vehicle notification system, the vehicle notification system comprising:
a notification feature communicatively coupled to a vehicle to notify a driver of the vehicle of a notification via the vehicle notification system;
one or more vehicle sensors associated with the vehicle;
one or more external data sources remote from the vehicle;
at least one processor communicatively coupled to the notification feature, the one or more vehicle sensors, and the one or more external data sources;
a memory communicatively coupled to the at least one processor; and
one or more machine readable instructions stored in the memory that cause the vehicle notification system to perform at least the following when executed by the at least one processor:
request, via the notification feature, access to driver financial information associated with the driver of the vehicle;
receive, from the driver and via the notification feature, permission to access the driver financial information for a set time period;
access the driver financial information during the set time period; and
generate an insurance quote based on a plurality of metrics associated with the driver financial information during the set time period; and
transmit the notification of the insurance quote to the driver of the vehicle via the notification feature.

19. The vehicle notification system of claim 18, wherein the one or more machine readable instructions cause the vehicle notification system to further perform at least the following when executed by the at least one processor:
transmit the notification to the driver via a first type of the notification feature, the notification feature comprising one or more of a speaker feature, a microphone feature, a lighting feature, an augmented reality display of the vehicle, a graphical user interface, or combinations thereof;
receive an acceptance of the insurance quote offered via the notification transmitted to the driver through a second type of the notification feature, wherein the second type of the notification feature is one of the same or different from the first type of the notification feature.

20. The vehicle notification system of claim 18, wherein the driver financial information comprises a driver bank account associated with the driver of the vehicle, and the plurality of metrics are indicative of an ability of the driver to pay the insurance quote and comprise:
an account number;
a checking account balance;
a savings account balance;
a transaction history;
account fees;
one or more credit card accounts;
an account status, or
combinations thereof.
